(19) United States
(12) Patent Application Publication
(10) Pub. No.: US 2024/0086947 A1
(43) Pub. Date: Mar. 14, 2024

(54) INTELLIGENT PREDICTION OF SALES OPPORTUNITY OUTCOME

(71) Applicant: Dell Products L.P., Round Rock, TX (US)

(72) Inventors: Manoj Nambirajan, Hyderabad (IN); Mohit Kumar Agarwal, Karnataka (IN); Bijan Kumar Mohanty, Austin, TX (US); Hung Dinh, Austin, TX (US)

(73) Assignee: Dell Products L.P., Round Rock, TX (US)

(21) Appl. No.: 17/931,618

(22) Filed: Sep. 13, 2022

(51) Int. Cl. G06Q 30/02; G06N 3/04

(52) U.S. Cl. CPC G06Q 30/0205; G06N 3/04; G06Q 30/0201

(57) ABSTRACT

In one aspect, an example methodology implementing the disclosed techniques includes, by a computing device, receiving information regarding a new sales opportunity from another computing device and determining one or more relevant features from the information regarding the new sales opportunity, the one or more relevant features influencing predictions of an opportunity outcome and an opportunity duration. The method also includes, by the computing device, generating, using a multi-target machine learning (ML) model, a first prediction of an opportunity outcome of the new sales opportunity and a second prediction of an opportunity duration of the new sales opportunity based on the determined one or more relevant features. The method may also include, by the computing device, sending the first and second predictions to the another computing device.

### BACKGROUND

Organizations, such as companies, enterprises, and manufacturers, continually grapple with having to determine whether a lead will ever be converted into a sales opportunity. A lead may be a potential customer, such as an individual, a contact, or a company, that has been identified as having an interest in a product or service offered by the organization. Leads may be generated in various ways, such as via referrals, marketing, social media, networking, product trials, or consultations. When a lead is qualified by the organization it is converted into a sales opportunity. Sales opportunities are essentially “deals in progress” and are processed by the organization to closure (e.g., either a winning deal or a losing deal).

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving information regarding a new sales opportunity from another computing device and determining one or more relevant features from the information regarding the new sales opportunity, the one or more relevant features influencing predictions of an opportunity outcome and an opportunity duration. The method also includes, by the computing device, generating, using a multi-target machine learning (ML) model, a first prediction of an opportunity outcome of the new sales opportunity and a second prediction of an opportunity duration of the new sales opportunity based on the determined one or more relevant features. The method may also include, by the computing device, sending the first and second predictions to the another computing device.

In some embodiments, the multi-target ML model includes a multi-output deep neural network (DNN). In one aspect, the multi-output DNN predicts a classification response and a regression response, wherein the classification response is the first prediction of the opportunity outcome of the new sales opportunity and the regression response is the second prediction of the opportunity duration of the new sales opportunity.

In some embodiments, the multi-target ML model is generated using a modeling dataset generated from a corpus of historical sales opportunity and deal closure data of an organization.

In some embodiments, the one or more relevant features includes a feature indicative of a customer associated with the new sales opportunity.

In some embodiments, the one or more relevant features includes a feature indicative of a type of opportunity associated with the new sales opportunity.

In some embodiments, the one or more relevant features includes a feature indicative of an individual tasked to close the new sales opportunity.

In some embodiments, the one or more relevant features includes a feature indicative of a product associated with the new sales opportunity.

In some embodiments, the one or more relevant features includes a feature indicative of a quantity of a product associated with the new sales opportunity.

In some embodiments, the one or more relevant features includes a feature indicative of a geographic region associated with the new sales opportunity.

In some embodiments, the one or more relevant features includes a feature indicative of a deal price associated with the new sales opportunity.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a block diagram of an illustrative network environment for intelligent sales opportunity outcome prediction, in accordance with an embodiment of the present disclosure.

FIG. 1B is a block diagram of an illustrative sales opportunity conversion service, in accordance with an embodiment of the present disclosure.

FIG. 2 is a diagram illustrating a portion of a data structure that can be used to store information about relevant features of a modeling dataset for training a multi-target machine learning (ML) model to predict a sales opportunity outcome and a sales opportunity duration, in accordance with an embodiment of the present disclosure.

FIG. 3 is a diagram illustrating an example architecture of a multi-output deep neural network (DNN) for an opportunity conversion module, in accordance with an embodiment of the present disclosure.

FIG. 4 is a diagram showing an example topology that can be used to predict an opportunity outcome and an opportunity duration, in accordance with an embodiment of the present disclosure.

FIG. 5 is a flow diagram of an example process for predictions of an opportunity outcome and an opportunity duration, in accordance with an embodiment of the present disclosure.

FIG. 6 is a block diagram illustrating selective components of an example computing device in which various aspects of the disclosure may be implemented, in accordance with an embodiment of the present disclosure.

### DETAILED DESCRIPTION

Organizations need to properly prioritize their sales opportunities (sometimes referred to herein more simply as “opportunities” or “opportunity” in the singular form) to optimize the sales process, increase the chances of opportunities to close to winning deals, and generate more revenue. However, properly prioritizing the opportunities based on their potential (e.g., potential of the sales opportunity closing to a winning deal) can be challenging. Existing customer relationship management (CRM) and sales management processes, including the plethora of CRM and sales management tools that are available to the sales team, fail to provide the necessary insights about the outcome of an opportunity at the time of opportunity creation. In the absence of this insight, the sales team is likely to place equal priority to all the opportunities that are created and is unable to target their focus and efforts on the opportunities that are more likely to close to winning deals (e.g., the opportunities with the highest potential). This results in low opportunity win rates which is out-of-line with the organization's business goals and objectives. This situation is compounded where a large volume of opportunities is created. For example, an opportunity having high potential may stay open meaning that the organization's sales team has not yet made a sales call or conducted a meeting with the opportunity. Opportunities that stay open for extended durations are likely to get canceled eventually, thus nullifying the process and effort expended to create the opportunities (e.g., effort put into the qualified lead conversion). In many cases, the loss may be due to a competitor executing a better selling process and stealing the opportunity from the organization. Such losses can be a disappointing and unsatisfactory outcome for sales resulting in loss of time, effort, morale, and revenue for the organization.

Certain embodiments of the concepts, techniques, and structures disclosed herein are directed to an artificial intelligence (AI)/machine learning (ML)-powered framework for predicting whether a sales opportunity will close to a winning deal (or a “sale”) and predicting an estimated duration the sales opportunity will take to close, either to a winning deal or a losing deal. The sales opportunity (sometimes referred to herein more simply as an “opportunity”) may belong to or otherwise be associated with an organization such as a company or other enterprise. In some embodiments, the predictions of an opportunity outcome (i.e., prediction of whether the opportunity will close to a winning deal) and an opportunity duration (i.e., a prediction of an estimated time the opportunity will take to close) can be achieved using a multi-target ML model generated using the organization's historical opportunity and deal closure data. For example, in some such embodiments, an ML algorithm that supports outputting multiple predictions, such as a deep neural network (DNN), may be trained using a modeling dataset generated from the organization's multi-dimensional historical opportunity and deal closure data. The historical opportunity and deal closure data include data about the historical opportunities, duration the historical opportunities took to close, and the outcome of the historical opportunities (e.g., whether a historical opportunity closed to a won deal). The historical opportunity and deal closure data may be modeled and viewed in multiple dimensions (e.g., the historical opportunity and deal closure data may be viewed in the form of a data cube).

In some embodiments, the historical opportunity and deal closure data can be a dataset with a large number of different features (or “attributes”). Such features may include insights and datapoints about the organization's historical (or “past”) opportunities and the person(s) (e.g., the sales associate or team) and/or sub-organizations within the organization assigned to the historical opportunities (e.g., tasked to close the historical opportunities). For example, for a given historical opportunity, the opportunity data may include information about the customer, the type of opportunity, the sales associate assigned to the opportunity, product(s) the customer is interested in, quantities of the product(s), geographical region associated with the opportunity, and the deal price, among others, and the deal closure data may include information about the outcome of the historical opportunity (e.g., won deal or lost deal) and duration the historical opportunity took to close. The historical opportunity and deal closure data may be collected from the organization's CRM and sales systems and various other sources. The resulting multi-target ML model (e.g., the trained multi-output DNN) can, in response to input of a new opportunity (e.g., input of information about the organization's new opportunity), output two predictions simultaneously: one prediction of an opportunity outcome of the new opportunity and another prediction of an opportunity duration of the new opportunity. The organization (e.g., management) can then decide how to prioritize the new opportunity. Predictions of new opportunity outcomes and new opportunity durations based on historical opportunity conversion insights and datapoints can help the organization deploy the sales team to focus on the new opportunities that have better potential, which contributes to increase sales for its products or services.

The use of the multi-target ML model to output the two predictions simultaneously may provide benefits over using a combination of two separate single output ML models. For example, training two single output ML models may take longer and be more computationally expensive than training the multi-target ML model in accordance with implementations of this disclosure. As another example, training the multi-target ML model in accordance with implementations of this disclosure may optimize for the multiple targets (e.g., two targets) together which may improve the accuracy of the output predictions compared to optimizing for a single target as in the case of using single output ML models.

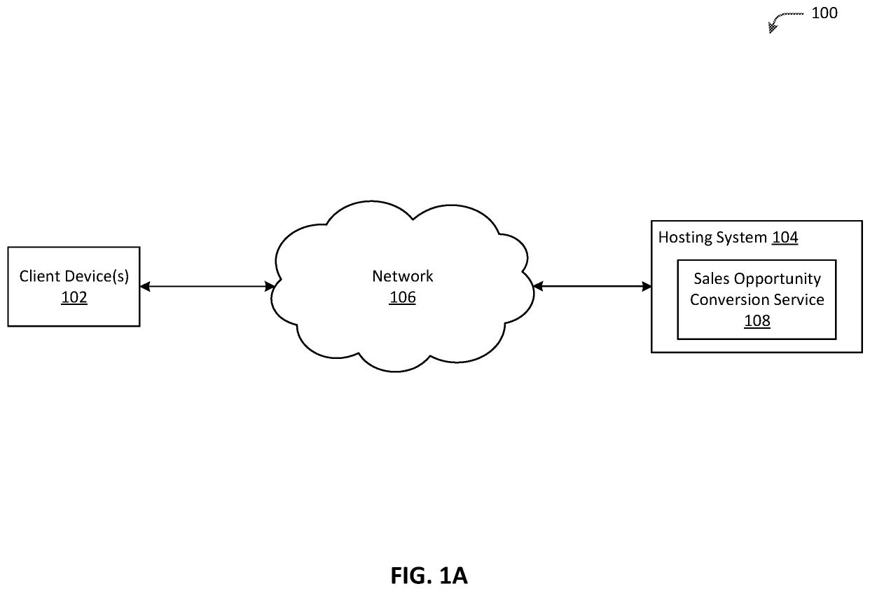

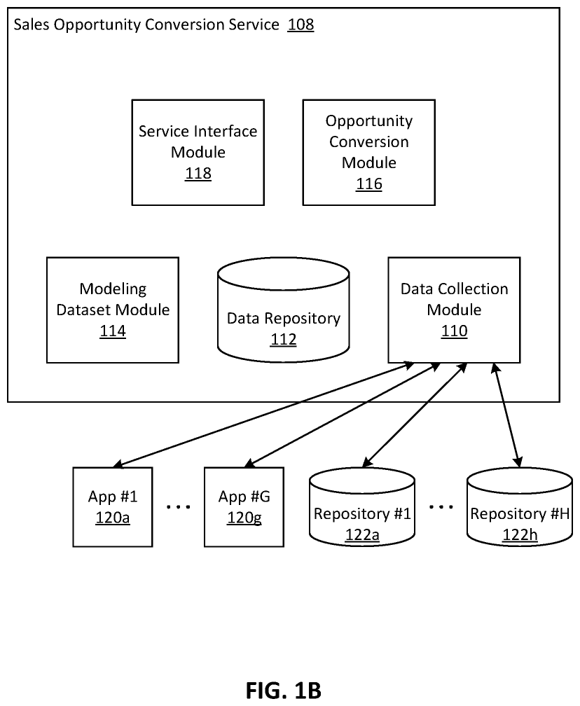

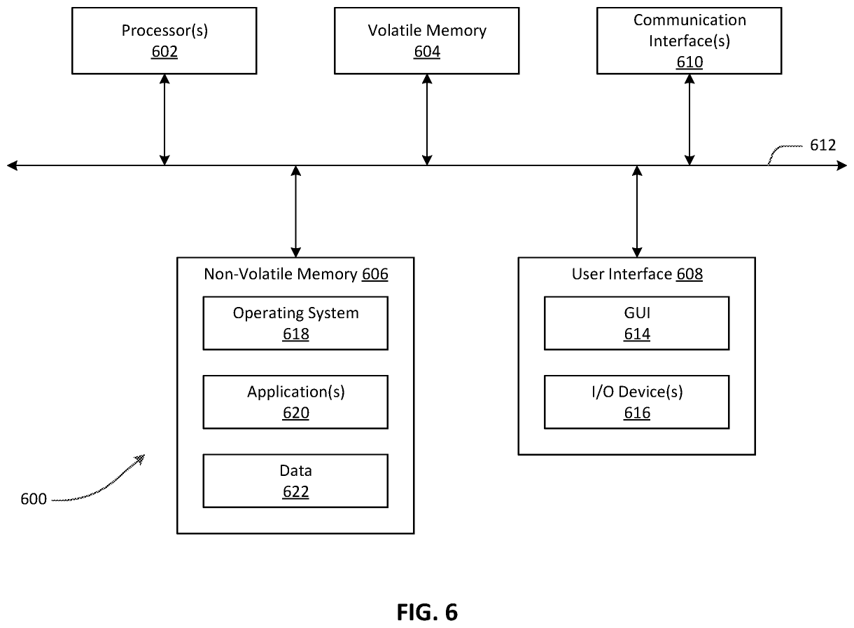

Turning now to the figures, FIG. 1A is a block diagram of an illustrative network environment 100 for intelligent sales opportunity outcome prediction, in accordance with an embodiment of the present disclosure. As illustrated, network environment 100 may include one or more client devices 102 communicatively coupled to a hosting system 104 via a network 106. Client devices 102 can include smartphones, tablet computers, laptop computers, desktop computers, workstations, or other computing devices configured to run user applications (or “apps”). In some implementations, client devices 102 may be substantially similar to a computing device 600, which is further described below with respect to FIG. 6.

Hosting system 104 can include one or more computing devices that are configured to host and/or manage applications and/or services. Hosting system 104 may include load balancers, frontend servers, backend servers, authentication servers, and/or any other suitable type of computing device. For instance, hosting system 104 may include one or more computing devices that are substantially similar to computing device 600, which is further described below with respect to FIG. 6.

In some embodiments, hosting system 104 can be provided within a cloud computing environment, which may also be referred to as a cloud, cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

As shown in FIG. 1A, hosting system 104 may include a sales opportunity conversion service 108. As described in further detail at least with respect to FIGS. 1B-5, sales opportunity conversion service 108 is generally configured to predict an opportunity outcome and an opportunity duration using a multi-target ML model (e.g., a multi-output DNN). That is to say, for a given opportunity, sales opportunity conversion service 108 can predict an opportunity outcome, e.g., predict whether the opportunity will close to a winning deal, and an opportunity duration, e.g., predict an estimated time the opportunity will take to close. The predictions of an opportunity outcome and an opportunity duration may be for a new opportunity of the organization. Briefly, in one example use case, a user associated with the organization, such as a member of the organization's sales team, can use a client application on their client device 102 to access sales opportunity conversion service 108. For example, the client application may provide user interface (UI) controls that the user can click/tap/interact with to access sales opportunity conversion service 108 and issue a request for an opportunity conversion determination (e.g., send a request to determine whether an opportunity (e.g., a new opportunity) will close to a winning deal). The client application may also provide UI elements (e.g., an opportunity details form) with which the user can specify details about an opportunity for which the opportunity conversion determination is being requested. In response to such request being received, opportunity conversion service 108 can predict an opportunity outcome and an opportunity duration for the specified opportunity and send indications of the predictions (i.e., prediction of the opportunity outcome and the prediction of the opportunity duration) in a response to the client application. In response to receiving the response, the client application can present the response (e.g., the indicated predictions) within a UI (e.g., a graphical user interface) for viewing by the user. The user can then take appropriate action based on the provided predictions. For example, the user may prioritize the opportunity for assignment to a sales associate.

FIG. 1B is a block diagram of an illustrative sales opportunity conversion service 108, in accordance with an embodiment of the present disclosure. For example, an organization such as a company, an enterprise, or other entity that sells or otherwise provides products and/or services, for instance, may implement and use sales opportunity conversion service 108 to intelligently predict an opportunity outcome and an opportunity duration for an opportunity (e.g., a new opportunity of the organization). Sales opportunity conversion service 108 can be implemented as computer instructions executable to perform the corresponding functions disclosed herein. Sales opportunity conversion service 108 can be logically and/or physically organized into one or more components. The various components of sales opportunity conversion service 108 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 1B, sales opportunity conversion service 108 includes a data collection module 110, a data repository 112, a modeling dataset module 114, an opportunity conversion module 116, and a service interface module 118. Sales opportunity conversion service 108 can include various other components (e.g., software and/or hardware components) which, for the sake of clarity, are not shown in FIG. 1B. It is also appreciated that sales opportunity conversion service 108 may not include certain of the components depicted in FIG. 1B. For example, in certain embodiments, sales opportunity conversion service 108 may not include one or more of the components illustrated in FIG. 1B (e.g., modeling dataset module 114), but sales opportunity conversion service 108 may connect or otherwise couple to the one or more components via a communication interface. Thus, it should be appreciated that numerous configurations of sales opportunity conversion service 108 can be implemented and the present disclosure is not intended to be limited to any particular one. That is, the degree of integration and distribution of the functional component(s) provided herein can vary greatly from one embodiment to the next, as will be appreciated in light of this disclosure.

Referring to sales opportunity conversion service 108, data collection module 110 is operable to collect or otherwise retrieve the organization's historical opportunity and deal closure data from one or more from one or more data sources. The data sources can include, for example, one or more applications 120a-120g (individually referred to herein as application 120 or collectively referred to herein as applications 120) and one or more repositories 122a-122h (individually referred to herein as repository 122 or collectively referred to herein as repositories 122). Applications 120 can include various types of applications such as software as a service (SaaS) applications, web applications, and desktop applications, to provide a few examples. In some embodiments, applications 120 may correspond to the organization's customer management applications and sales management applications such as customer relationship management (CRM) system and/or a sales management system. Repositories 122 can include various types of data repositories such as conventional file systems, cloud-based storage services such as SHAREFILE, BITBUCKET, DROPBOX, and MICROSOFT ONEDRIVE, and web servers that host files, documents, and other materials. In some embodiments, repositories 122 may correspond to the organization's repositories used for storing at least some of the historical opportunity and deal closure data.

Data collection module 110 can utilize application programming interfaces (APIs) provided by the various data sources to collect information and materials therefrom. For example, data collection module 110 can use a REST-based API or other suitable API provided by a customer management application/system or sales management application/system to collect information therefrom (e.g., to collect the historical opportunity and deal closure data). In the case of web-based applications, data collection module 110 can use a Web API provided by a web application to collect information therefrom. As another example, data collection module 110 can use a file system interface to retrieve the files containing historical opportunity and deal closure data and related information, etc., from a file system. As yet another example, data collection module 110 can use an API to collect documents containing historical opportunity and deal closure data and related information, etc., from a cloud-based storage service. A particular data source (e.g., a customer management application/system, sales management application/system, and/or data repository) can be hosted within a cloud computing environment (e.g., the cloud computing environment of sales opportunity conversion service 108 or a different cloud computing environment) or within an on-premises data center (e.g., an on-premises data center of an organization that utilizes sales opportunity conversion service 108).

In cases where an application or data repository does not provide an interface or API, other means, such as printing and/or imaging, may be utilized to collect information therefrom (e.g., generate an image of printed document containing information/data about a historical opportunity). Optical character recognition (OCR) technology can then be used to convert the image of the content to textual data.

As mentioned previously, data collection module 110 can collect the historical opportunity and deal closure data from one or more data sources. The historical opportunity and deal closure data includes historical opportunity data which can include insights and datapoints about the past opportunities of the organization (e.g., data about the historical opportunities and the persons and/or sub-organizations within the organization assigned to the historical opportunities). For a given historical opportunity, the deal closure data can include conversion data which indicates whether the historical opportunity closed to a won deal (or a lost deal) and the duration the historical opportunity took to close (i.e., time taken to close the historical opportunity to either a won deal or a lost deal). Data collection module 110 can store the historical opportunity and deal closure data collected from the various data sources within data repository 112, where it can subsequently be retrieved and used. For example, the historical opportunity and deal closure data and other materials from data repository 112 can be retrieved and used to generate a modeling dataset for use in generating an ML model (e.g., a multi-target ML model). In some embodiments, data repository 112 may correspond to a storage service within the computing environment of sales opportunity conversion service 108.

In some embodiments, data collection module 110 can collect the opportunity and deal closure data from one or more of the various data sources on a continuous or periodic basis (e.g., according to a predetermined schedule specified by the organization). For example, data collection module 110 can collect the historical opportunity and deal closure data for or associated with the organization's opportunities from the preceding 12 months, 18 months, or another suitable period. The period for the historical opportunities whose opportunity and deal closure data are to be collected may be configurable by the organization. Additionally or alternatively, data collection module 110 can collect the historical opportunity and deal closure data from one or more of the various data sources in response to an input. For example, a user of sales opportunity conversion service 108 can use their client device 102 and issue a request to collect historical opportunity and deal closure data from one or more data sources. The request may indicate a period for the historical opportunities whose opportunity and deal closure data are to be collected. In response, data collection module 110 can collect the historical opportunity and deal closure data from the one or more data sources.

Modeling dataset module 114 is operable to generate (or “create”) a modeling dataset for use in generating (e.g., training, testing, etc.) a ML model (e.g., a multi-target ML model) to predict an opportunity outcome and an opportunity duration. Modeling dataset module 114 can retrieve from data repository 112 a corpus of historical opportunity and deal closure data from which to generate the modeling dataset. In one embodiment, one, two, or more years of historical opportunity and deal closure data can be retrieved from which to create the modeling dataset. The amount of historical opportunity and deal closure data to retrieve and use to create the modeling dataset may be configurable by the organization.

To generate a modeling dataset, modeling dataset module 114 may preprocess the retrieved corpus of historical opportunity and deal closure data to be in a form that is suitable for training and testing the ML model (e.g., a multi-target ML model). In one embodiment, modeling dataset module 114 may utilize natural language processing (NLP) algorithms and techniques to preprocess the retrieved historical opportunity data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stop words removal, stemming, and/or lemmatization.

The data preprocessing may also include placing the data into a tabular format. In the table, the structured columns represent the features (also called “variables”) and each row represents an observation or instance (e.g., a historical opportunity). Thus, each column in the table shows a different feature of the instance. The data preprocessing may also include placing the data (information) in the table into a format that is suitable for training a model (e.g., placing into a format that is suitable for a DNN or other suitable learning algorithm to learn from to generate (or “build”) the ML model, e.g., a multi-target ML model). For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The data preprocessing may also include null data handling (e.g., the handling of missing values in the table). According to one embodiment, null or missing values in a column (a feature) may be replaced by mean of the other values in that column. For example, mean imputation may be performed using a mean imputation technique such as that provided by Scikit-learn (Sklearn). According to alternative embodiments, observations in the table with null or missing values in a column may be replaced by a mode or median value of the values in that column or removed from the table.

The data preprocessing may also include feature selection and/or data engineering to determine or identify the relevant or important features from the noisy data. The relevant/important features are the features that are more correlated with the thing being predicted by the trained model (e.g., an opportunity outcome and an opportunity duration). A variety of feature engineering techniques, such as exploratory data analysis (EDA) and/or bivariate data analysis with multivariate-variate plots and/or correlation heatmaps and diagrams, among others, may be used to determine the relevant features. The relevant features are the features that are more correlated with the thing being predicted by the trained model. For example, for a particular historical opportunity, the relevant features may include important features from the historical opportunity such as the customer/account, the type of opportunity, the sales associate assigned to the opportunity, product(s) the customer is interested in, quantities of the product(s), geographical region associated with the opportunity, and the deal price, among others.

The data preprocessing can include adding an informative label to each instance in the modeling dataset. As explained above, each instance in the modeling dataset is a historical opportunity of the organization. In some implementations, one or more labels (e.g., an indication of opportunity outcome (e.g., won deal or lost deal) and an indication of opportunity duration) can be added to each instance in the modeling dataset. The label added to each instance, i.e., the label added to each historical opportunity, is a representation of a prediction for that instance in the modeling dataset (e.g., the things being predicted) and helps a machine learning model learn to make the prediction when encountered in data without a label. For example, for a given historical opportunity, a first label may indicate whether the historical opportunity closed to a won deal and a second label may indicate a duration the historical opportunity took to close.

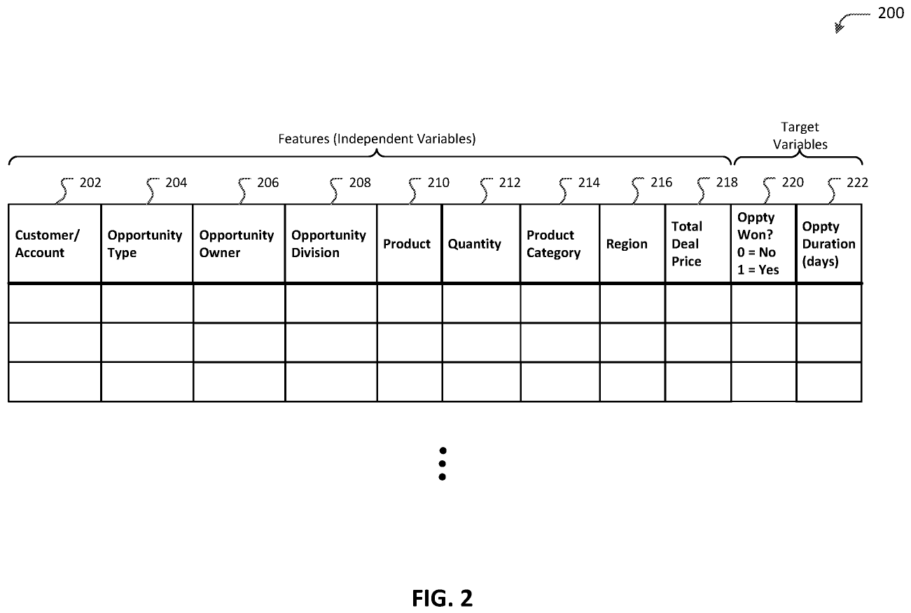

Each instance in the table may represent a training/testing sample (i.e., an instance of a training/testing sample) in the modeling dataset and each column may be a relevant feature of the training/testing sample. As previously described, each training/testing sample may correspond to a historical opportunity of the organization. In a training/testing sample, the relevant features are the independent variables and the things being predicted (e.g., an opportunity outcome and an opportunity duration) are the dependent variables (e.g., labels). In some embodiments, the individual training/testing samples may be used to generate a feature vector, which is a multi-dimensional vector of elements or components that represent the features in a training/testing sample. In such embodiments, the generated feature vectors may be used for training or testing a multi-target ML model using supervised learning to make the predictions. Examples of relevant features of a modeling dataset for training/testing the multi-target ML model for predicting an opportunity outcome and an opportunity duration is provided below with respect to FIG. 2.

In some embodiments, modeling dataset module 114 may reduce the number of features in the modeling dataset. For example, since the modeling dataset is being generated from the corpus of historical opportunity and deal closure data, the number of features (or input variables) in the dataset may be very large. The large number of input features can result in poor performance for machine learning algorithms. For example, in one embodiment, modeling dataset module 114 can utilize dimensionality reduction techniques, such as principal component analysis (PCA), to reduce the dimension of the modeling dataset (e.g., reduce the number of features in the dataset), hence improving the model's accuracy and performance.

In some embodiments, modeling dataset module 114 can generate the modeling dataset on a continuous or periodic basis (e.g., according to a predetermined schedule specified by the organization). For example, modeling dataset module 114 can generate the modeling dataset according to a preconfigured schedule. Additionally or alternatively, modeling dataset module 114 can generate the modeling dataset in response to an input. For example, a user of sales opportunity conversion service 108 can use their client device 102 and issue a request to generate a modeling dataset. In some cases, the request may indicate an amount of historical opportunity and deal closure data to use in generating the modeling dataset. In response, modeling dataset module 114 can retrieve the historical opportunity and deal closure data for generating the modeling dataset from data repository 112 and generate the modeling dataset using the retrieved historical opportunity and deal closure data. Modeling dataset module 114 can store the generated modeling dataset within data repository 112, where it can subsequently be retrieved and used (e.g., retrieved and used to build a multi-target ML model for predicting an opportunity outcome and an opportunity duration).

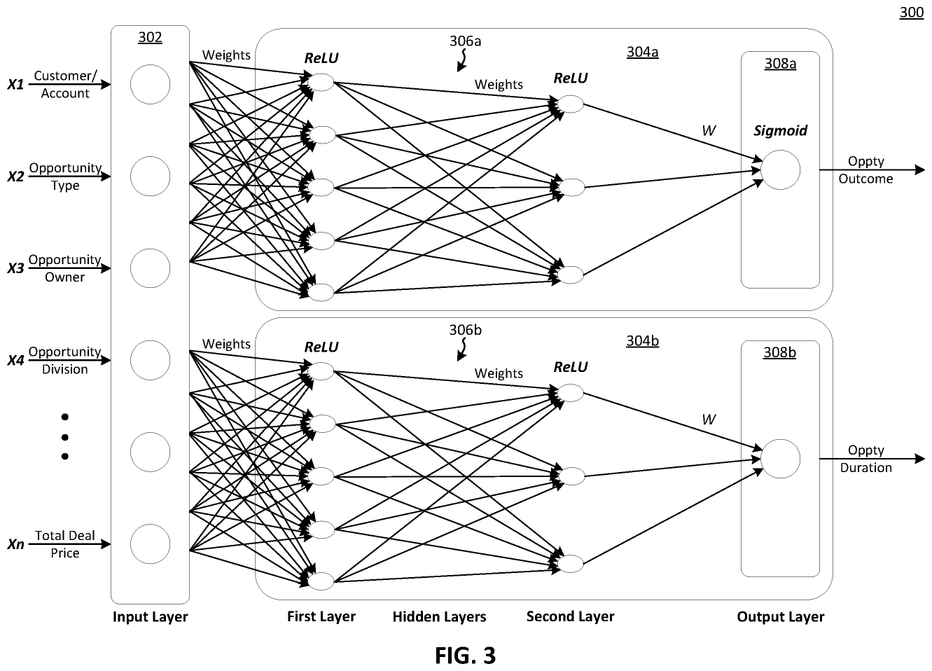

Still referring to sales opportunity conversion service 108, opportunity conversion module 116 is operable to predict an opportunity outcome and an opportunity duration. In other words, opportunity conversion module 116 is operable to predict, for an input of information about an opportunity (e.g., a new opportunity), whether the opportunity will close to a winning deal and an estimated time the opportunity will take to close. In some embodiments, opportunity conversion module 116 can include an ML algorithm that supports outputting multiple predictions, such as a DNN, trained to simultaneously predict a classification response and predict a regression response using a modeling dataset generated from the organization's multi-dimensional historical opportunity and deal closure data. The modeling dataset may be retrieved from data repository 112. Once the multi-target ML model is trained, the output classification response can be a prediction of an opportunity outcome and the output regression response can be a prediction of an opportunity duration. For example, in response to input of information about an opportunity, the multi-target ML model can predict an opportunity outcome and an opportunity duration of the input opportunity based on the learned behaviors (or “trends”) in the modeling dataset. Further description of the training of the ML algorithm that supports outputting multiple predictions (e.g., a DNN) implemented within opportunity conversion module 116 is provided below at least with respect to FIG. 3.

On other embodiments, opportunity conversion module 116 can implement two separate single output ML models instead of the multi-target ML model described above. For example, opportunity conversion module 116 can include an ML classification model and an ML regression model both generated from the organization's multi-dimensional historical opportunity and deal closure data. The trained ML classification model can, in response to input of information about an opportunity, predict an opportunity outcome of the input opportunity. The trained ML regression model can, in response to input of the information about the opportunity, predict an opportunity duration of the input opportunity.

Service interface module 118 is operable to provide an interface to sales opportunity conversion service 108. For example, in one embodiment, service interface module 118 may include an API that can be utilized, for example, by client applications to communicate with sales opportunity conversion service 108. For example, a client application, such as an opportunity conversion service client application, on a client device (e.g., client device 102 of FIG. 1A) can send requests (or “messages”) to sales opportunity conversion service 108 wherein the requests are received and processed by service interface module 118. Likewise, sales opportunity conversion service 108 can utilize service interface module 118 to send responses/messages to the client application on the client device.

In some embodiments, service interface module 118 may include user interface (UI) controls/elements which may be presented on a UI of the client application on the client device and utilized to access sales opportunity conversion service 108. For example, a user can click/tap/interact with the presented UI controls/elements to specify information (e.g., details) about a new opportunity and send a request for an opportunity conversion determination. In response to the user's input, the client application on the client device may send a request to sales opportunity conversion service 108 for predictions of an opportunity outcome and an opportunity duration. The client application on the client device may also send the specified information about the new opportunity with the request. In response to the request from the client application, sales opportunity conversion service 108 can utilize opportunity conversion module 116 to predict an opportunity outcome and an opportunity duration of the new opportunity. Sales opportunity conversion service 108 can then send the predictions (e.g., prediction of the opportunity outcome and prediction of the opportunity duration of the new opportunity) to the client application for presenting to the user of the client application, for example. As another example, a user can click/tap/interact with the presented UI controls/elements to issue a request to collect historical opportunity and deal closure data. The user may use a presented UI control/element to specify a period for the historical opportunity and deal closure data which is to be collected (e.g., collect opportunity and deal closure data for historical opportunities from a specified period such as from the preceding 12 months, 18 months, 24 months, or any other specified period). In response to the user's input, the client application on the client device may send a request to sales opportunity conversion service 108 to collect historical opportunity and deal closure data for opportunities from the specified period. In response to the request from the client application, sales opportunity conversion service 108 can utilize data collection module 110 to collect the historical opportunities and deal closure data. As still another example, a user can click/tap/interact with the presented UI controls/elements to issue a request to generate a modeling dataset and specify an amount of historical opportunities and deal closure data to use in generating the modeling dataset. In response to the user's input, the client application on the client device may send a request to sales opportunity conversion service 108 to generate a modeling dataset. In response to the request from the client application, sales opportunity conversion service 108 can utilize modeling dataset module 114 to generate a modeling dataset. Generally, the presented UI controls/elements can be used to interact with sales opportunity conversion service 108 (e.g., send requests to and receive responses from sales opportunity conversion service 108).

Referring now to FIG. 2 and with continued reference to FIGS. 1A and 1B, shown is a diagram illustrating a portion of a data structure 200 that can be used to store information about relevant features of a modeling dataset for training a multi-target machine learning (ML) model to predict a sales opportunity outcome and a sales opportunity duration, in accordance with an embodiment of the present disclosure. For example, the modeling dataset including the illustrated features, including other features generated from the organization's historical opportunity and deal closure data may be used to train a multi-output DNN to predict an opportunity outcome and an opportunity duration. As can be seen in FIG. 2, data structure 200 may be in a tabular format in which the structured columns represent the different relevant features (variables) regarding the historical opportunity data of the organization and a row represents individual historical opportunities. The relevant features illustrated in data structure 200 are merely examples of features that may be extracted from the historical opportunity data and used to generate a modeling dataset and should not be construed to limit the embodiments described herein.

As shown in FIG. 2, the relevant features may include a customer/account 202, an opportunity type 204, an opportunity owner 206, an opportunity division 208, a product 210, a quantity 212, a product category 214, a region 216, a total deal price 218, an opportunity won 220 and an opportunity duration 222. Customer/account 202 indicates a customer or potential customer associated with the historical opportunity. Opportunity type 204 indicates a type of historical opportunity. For example, opportunity type 204 may indicate that the historical opportunity was created indirectly with the assistance of a partner (e.g., with the assistance of a channel partner). As another example, opportunity type 204 may indicate that the historical opportunity was created directly by or with the customer. As still another example, opportunity type 204 may indicate that the historical opportunity that is pursued by the organization based upon a fixed scheduled (e.g., every quarter, annually, etc.).

Opportunity owner 206 indicates a person associated with the organization who was assigned to the historical opportunity. For example, the indicated person may be a member of the organization's sales team who was responsible for or tasked with closing the historical opportunity. Opportunity division 208 indicates the division or sub-organization within the organization assigned to the historical opportunity. For example, the indicated division or sub-organization may the division or sub-organization associated with the person indicated in opportunity owner 206. Product 210 indicates a product (e.g., a product number of a product) associated with the historical opportunity. For example, the indicated product may be the product that is of interest to the customer. Quantity 212 indicates a quantity of the product indicated in product 210 associated with the historical opportunity (e.g., a quantity of the organization's product indicated in product 210 that is of interest to the customer). Note that only one product (e.g., product 210) and one quantity of the product (e.g., quantity 212) are shown as relevant features in data structure 200 for purposes of clarity, and it will be appreciated that the relevant features can include more than one product and more than one quantity of the product as a historical opportunity may be associated with one or more of the organization's products.

Product category 214 indicates a category of the product associated with the historical opportunity. For example, the category may be a group of similar products and/or services produced and/or sold by the organization that share related characteristics (e.g., “servers”, “storage”, “networking”, “gaming”, etc.). The organization may create product categories to focus on promoting certain product categories to meet customer expectations. Region 216 indicates the geographical region (e.g., Asia, Pacific, and Japan (APJ), North and South America (AMER), Europe, Middle East, and Africa (EMEA), etc.) associated with the historical opportunity (e.g., a geographical region in which the organization is doing business and to which the customer belongs). Total deal price 218 indicates the total price of the historical opportunity. Opportunity won 220 indicates whether the historical opportunity closed to a won deal (e.g., “1=Yes”) or a lost deal (e.g., “0=No”). Opportunity duration 222 indicates a duration (e.g., number of days) taken by the organization to close the historical opportunity to either a won deal or a closed deal. Opportunity won 220 and opportunity duration 222 are the labels added to the historical opportunity.

In data structure 200, each row may represent a training/testing sample (i.e., an instance of a training/testing sample) in the modeling dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing a multi-target ML model (e.g., a multi-output DNN of opportunity conversion module 116) to predict opportunity outcome and an opportunity duration of an opportunity (e.g., a new opportunity). The features customer/account 202, opportunity type 204, opportunity owner 206, opportunity division 208, product 210, quantity 212, product category 214, region 216, and total deal price 218 may be included in a training/testing sample as the independent variables, and opportunity won 220 and opportunity duration 222 included as two dependent variables (target variables) in the training/testing sample. The illustrated independent variables are features that influence performance of the multi-target ML model (i.e., features that are relevant (or influential) in predicting an opportunity outcome and an opportunity duration).

Referring now to FIG. 3 and with continued reference to FIGS. 1B and 2, illustrated is an example architecture of a multi-output deep neural network (DNN) for an opportunity conversion module, in accordance with an embodiment of the present disclosure. In brief, a DNN includes an input layer for all input variables, multiple hidden layers for feature extraction, and an output layer. Each layer may be comprised of a number of nodes or units embodying an artificial neuron (or more simply a “neuron”). Each neuron in a layer receives an input from all the neurons in the preceding layer. In other words, every neuron in each layer is connected to every neuron in the preceding layer and the succeeding layer. As a multi-output DNN, a first output can be a classification response (e.g., a prediction of an opportunity outcome) and a second output can be a regression response (e.g., a prediction of an opportunity duration).

In more detail, and as shown in FIG. 3, a multi-output DNN 300 includes an input layer 302 and two network branches 304a, 304b. Network branch 304a includes multiple hidden layers 306a and an output layer 308a. Network branch 304b includes multiple hidden layers 306b (e.g., two hidden layers) and an output layer 308b. As illustrated in FIG. 3, network branches 304a, 304b may be parallel branches within multi-output DNN 300. In some embodiments, network branch 304a can be trained as a binary classification model that outputs a classification response (e.g., a prediction of an opportunity outcome) and network branch 304b can be trained as a regression model that outputs a regression (i.e., numeric) response (e.g., a prediction of an opportunity duration).

With respect to network branch 304a, hidden layers 306a includes two hidden layers, a first hidden layer and a second hidden layer. Each hidden layer in hidden layers 306a can comprise an arbitrary number of neurons, which may depend on the number of neurons included in input layer 302. For example, input layer 302 may be comprised of a number of neurons to match (i.e., equal to) the number of input variables (independent variables). Taking as an example the independent variables illustrated in data structure 200 (FIG. 2), input layer 302 may include nine neurons to match the nine independent variables (e.g., customer/account 202, opportunity type 204, opportunity owner 206, opportunity division 208, product 210, quantity 212, product category 214, region 216, and total deal price 218), where each neuron in input layer 402 receives a respective independent variable. Each neuron in the first hidden layer of hidden layers 306a receives an input from all the neurons in input layer 302. Each neuron in the second hidden layer of hidden layers 306a receives an input from all the neurons in the first hidden layer of hidden layers 306b. As a binary classification model, output layer 308a includes a single neuron, which receives an input from all the neurons in the second hidden layer of hidden layers 306a.

Each neuron in hidden layers 306a and the neuron in output layer 308a may be associated with an activation function. For example, according to one embodiment, the activation function for the neurons in hidden layers 306a may be a rectified linear unit (ReLU) activation function. As network branch 304a is to function as a binary classification model, the activation function for the neuron in output layer 308a may be a sigmoid activation function. Since this is a dense neural network, as can be seen in FIG. 3, each neuron in input layer 302 and the different layers of network branch 304a may be coupled to one another. Each coupling (i.e., each interconnection) between two neurons may be associated with a weight, which may be learned during a learning or training phase. Each neuron may also be associated with a bias factor, which may also be learned during a training process. Since network branch 304a is to be used as a binary classifier, binary cross entropy may be used as the loss function, adaptive movement estimation (Adam) as the optimization algorithm, and “accuracy” as the validation metric. In other embodiments, unpublished optimization algorithm designed for neural networks (RMSprop) may be used as the optimization algorithm.

With respect to network branch 304b, hidden layers 306b includes two hidden layers, a first hidden layer and a second hidden layer. Each hidden layer in hidden layers 306b can comprise an arbitrary number of neurons, which may depend on the number of neurons included in input layer 302. Each neuron in the first hidden layer of hidden layers 306b receives an input from all the neurons in input layer 302. Each neuron in the second hidden layer of hidden layers 306b receives an input from all the neurons in the first hidden layer of hidden layers 306b. As a binary classification model, output layer 308b includes a single neuron, which receives an input from all the neurons in the second hidden layer of hidden layers 306b.

Each neuron in hidden layers 306b may be associated with an activation function. For example, according to one embodiment, the activation function for the neurons in hidden layers 306b may be a rectified linear unit (ReLU) activation function. As network branch 304b is to function as a regression model, the neuron in output layer 308b will not contain an activation function. Since this is a dense neural network, as can be seen in FIG. 3, each neuron in input layer 302 and the different layers of network branch 304a may be coupled to one another. Each coupling (i.e., each interconnection) between two neurons may be associated with a weight, which may be learned during the learning or training phase. Each neuron may also be associated with a bias factor, which may also be learned during the training process. Since network branch 304b is to be used as a regressor, mean squared error may be used as the loss function, adaptive movement estimation (Adam) as the optimization algorithm, and “mean squared error (mse); mean absolute error (mae)” as the validation metrics.

Although FIG. 3 shows hidden layers 306a, 306b each comprised of only two layers, it will be understood that hidden layers 306a, 306b may be comprised of a different number of hidden layers. Also, the number of neurons shown in the first layer and in the second layer of each hidden layer 306a, 306b is for illustration only, and it will be understood that actual numbers of neurons in the first layer and in the second layer of each hidden layer 306a, 306b may be based on the number of neurons in input layer 302.

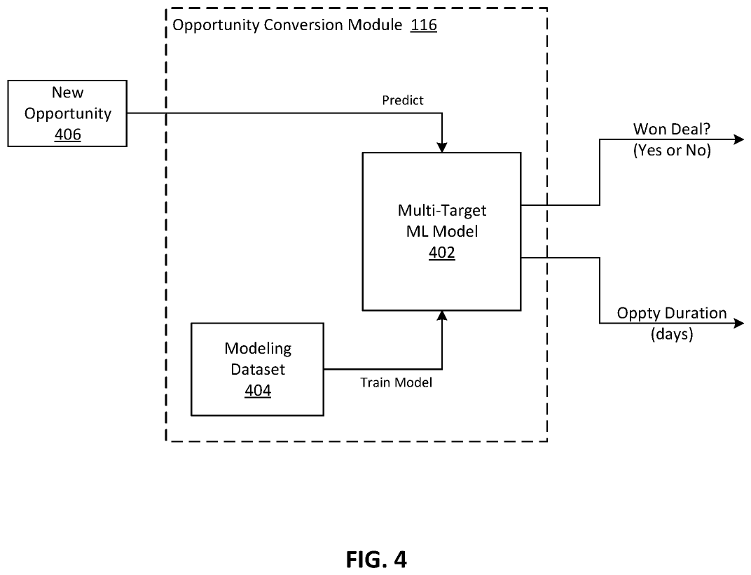

Referring now to FIG. 4, in which like elements of FIG. 1B are shown using like reference designators, shown is a diagram of an example topology that can be used to predict an opportunity outcome and an opportunity duration, in accordance with an embodiment of the present disclosure. As shown in FIG. 4, opportunity conversion module 116 includes a multi-target ML model 402. In some embodiments, multi-target ML model 402 may correspond to multi-output DNN 300 of FIG. 3. Multi-target ML model 402 may be can be trained and tested using machine learning techniques with a modeling dataset 404. Modeling dataset 404 can be retrieved from a data repository (e.g., data repository 112 of FIG. 1B). As described previously, modeling dataset 404 for multi-target ML model 402 may be generated from the collected corpus of the organization's historical opportunity and deal closure data. Once multi-target ML model 402 is sufficiently trained, opportunity conversion module 116 can, in response to receiving information regarding a new opportunity, predict an opportunity outcome and an opportunity duration of the new opportunity (e.g., predict whether the new opportunity will close to a winning deal and predict an estimated time the new opportunity will take to close). For example, as shown in FIG. 4, a feature vector 406 that represents a new opportunity, such as some or all the variables that may influence the predictions of an opportunity outcome and an opportunity duration, may be determined and input, passed, or otherwise provided to the trained multi-target ML model 402. In some embodiments, the input feature vector 406 (e.g., the feature vector representing the new opportunity) may include some or all the relevant features which were used in training multi-target ML model 402. In response to the input, the trained multi-target ML model 402 can output two responses: a classification response which is a prediction of an opportunity outcome of the new opportunity a won deal (e.g., “1=Won Deal” or “0=Lost Deal”) and a regression response which is a prediction of an opportunity duration of the new opportunity (e.g., an estimate of a number of days the new opportunity will take to close).

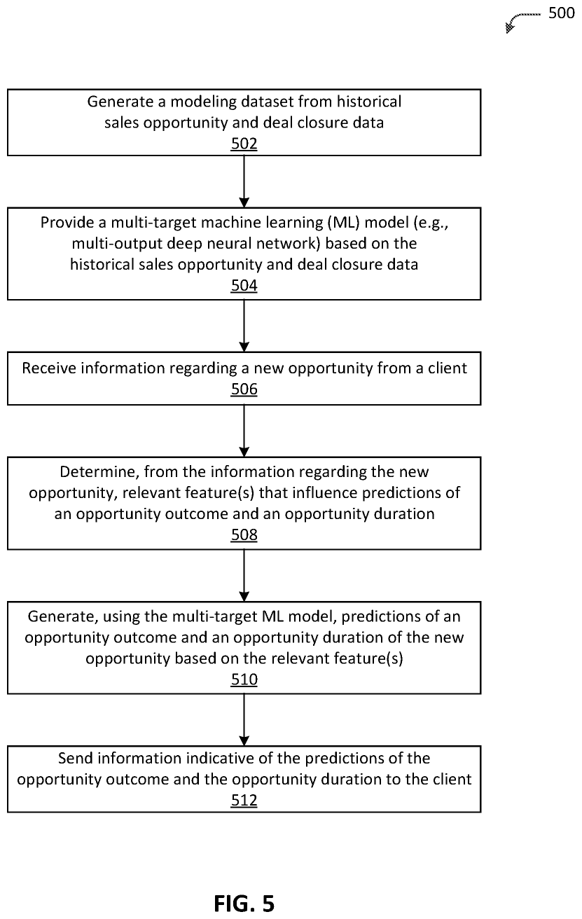

FIG. 5 is a flow diagram of an example process 500 for predictions of an opportunity outcome and an opportunity duration, in accordance with an embodiment of the present disclosure. Process 500 may be implemented or performed by any suitable hardware, or combination of hardware and software, including without limitation the components of network environment 100 shown and described with respect to FIGS. 1A and 1B, the computing device shown and described with respect to FIG. 6, or a combination thereof. For example, in some embodiments, the operations, functions, or actions illustrated in process 500 may be performed, for example, in whole or in part by data collection module 110, modeling dataset module 114, and opportunity conversion module 116, or any combination of these including other components of sales opportunity conversion service 108 described with respect to FIGS. 1A and 1B.

With reference to process 500 of FIG. 5, at 502, a modeling dataset for use in training a multi-target ML model may be generated from historical opportunity and deal closure data of an organization. For example, data collection module 110 may collect the historical opportunity and deal closure data from one or more data sources used by the organization to store or maintain such information/data and store the collected historical opportunity and deal closure data within data repository 112. Modeling dataset module 114 can then retrieve a corpus of historical opportunity and deal closure data from data repository 112, generate the modeling dataset, and store the modeling dataset within data repository 112.

At 504, a multi-target ML model trained or configured using the modeling dataset generated from some or all the collected historical opportunity and deal closure data may be provided. For example, an ML algorithm that supports outputting multiple predictions may be trained and tested using the modeling dataset (e.g., modeling dataset generated by modeling dataset module 114) to build the multi-target ML model. For example, in one implementation, modeling dataset module 114 may retrieve the modeling dataset from data repository 112 and use the modeling dataset to train a multi-output DNN. The trained multi-output DNN can, in response to receiving information regarding a new opportunity, output a classification response (e.g., a prediction of an opportunity outcome of the new opportunity) and a regression response (e.g., a prediction of an opportunity duration of the new opportunity).

At 506, information regarding a new opportunity may be received. For example, the information regarding the new opportunity may be received along with a request for an opportunity conversion determination from a client (e.g., client device 102 of FIG. 1A). In response to the information regarding the new opportunity being received, at 508, relevant feature(s) that influence predictions of an opportunity outcome and an opportunity duration may be determined from the received information regarding the new opportunity. For example, in one implementation, opportunity conversion module 116 may determine the relevant feature(s) that influence predictions of an opportunity outcome and an opportunity duration.

At 510, predictions of an opportunity outcome and an opportunity duration of the new opportunity may be generated. For example, opportunity conversion module 116 may generate a feature vector that represents the relevant feature(s) of the new opportunity. Opportunity conversion module 116 can then input the generated feature vector to the multi-target ML model (e.g., multi-output DNN), which outputs a first prediction of an opportunity outcome of the new opportunity and a second prediction of an opportunity duration of the new opportunity. The predictions generated using the multi-target ML model are based on the relevant feature(s) input to the multi-target ML model. The predictions by the multi-target ML model are based on the learned behaviors (or “trends”) in the modeling dataset used in training the multi-target ML model.

At 512, information indicative of the predictions of the opportunity outcome and the opportunity duration of the new opportunity may be sent or otherwise provided to the client and presented to a user (e.g., the user who sent the request for an opportunity conversion determination). For example, the information indicative of the predictions may be presented within a user interface of a client application on the client. The user can then take appropriate action based on the provided predictions (e.g., prioritize or not prioritize the new opportunity for assignment to a sales associate).

FIG. 6 is a block diagram illustrating selective components of an example computing device 600 in which various aspects of the disclosure may be implemented, in accordance with an embodiment of the present disclosure. As shown, computing device 600 includes one or more processors 602, a volatile memory 604 (e.g., random access memory (RAM)), a non-volatile memory 606, a user interface (UI) 608, one or more communications interfaces 610, and a communications bus 612.

Non-volatile memory 606 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 608 may include a graphical user interface (GUI) 614 (e.g., a touchscreen, a display, etc.) and one or more input/output (I/O) devices 616 (e.g., a mouse, a keyboard, a microphone, one or more speakers, one or more cameras, one or more biometric scanners, one or more environmental sensors, and one or more accelerometers, etc.).

Non-volatile memory 606 stores an operating system 618, one or more applications 620, and data 622 such that, for example, computer instructions of operating system 618 and/or applications 620 are executed by processor(s) 602 out of volatile memory 604. In one example, computer instructions of operating system 618 and/or applications 620 are executed by processor(s) 602 out of volatile memory 604 to perform all or part of the processes described herein (e.g., processes illustrated and described in reference to FIGS. 1A through 5). In some embodiments, volatile memory 604 may include one or more types of RAM and/or a cache memory that may offer a faster response time than a main memory. Data may be entered using an input device of GUI 614 or received from I/O device(s) 616. Various elements of computing device 600 may communicate via communications bus 612.

The illustrated computing device 600 is shown merely as an illustrative client device or server and may be implemented by any computing or processing environment with any type of machine or set of machines that may have suitable hardware and/or software capable of operating as described herein.

Processor(s) 602 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 602 may be analog, digital or mixed signal. In some embodiments, processor 602 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 610 may include one or more interfaces to enable computing device 600 to access a computer network such as a Local Area Network (LAN), a Wide Area Network (WAN), a Personal Area Network (PAN), or the Internet through a variety of wired and/or wireless connections, including cellular connections.

In described embodiments, computing device 600 may execute an application on behalf of a user of a client device. For example, computing device 600 may execute one or more virtual machines managed by a hypervisor. Each virtual machine may provide an execution session within which applications execute on behalf of a user or a client device, such as a hosted desktop session. Computing device 600 may also execute a terminal services session to provide a hosted desktop environment. Computing device 600 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, information regarding a new sales opportunity from another computing device;
determining, by the computing device, one or more relevant features from the information regarding the new sales opportunity, the one or more relevant features influencing predictions of an opportunity outcome and an opportunity duration;
generating, by the computing device using a multi-target machine learning (ML) model, a first prediction of an opportunity outcome of the new sales opportunity and a second prediction of an opportunity duration of the new sales opportunity based on the determined one or more relevant features; and
sending, by the computing device, the first and second predictions to the another computing device.

2. The method of claim 1, wherein the multi-target ML model includes a multi-output deep neural network (DNN).

3. The method of claim 2, wherein the multi-output DNN predicts a classification response and a regression response, wherein the classification response is the first prediction of the opportunity outcome of the new sales opportunity and the regression response is the second prediction of the opportunity duration of the new sales opportunity.

4. The method of claim 1, wherein the multi-target ML model is generated using a modeling dataset generated from a corpus of historical sales opportunity and deal closure data of an organization.

5. The method of claim 1, wherein the one or more relevant features includes a feature indicative of a customer associated with the new sales opportunity.

6. The method of claim 1, wherein the one or more relevant features includes a feature indicative of a type of opportunity associated with the new sales opportunity.

7. The method of claim 1, wherein the one or more relevant features includes a feature indicative of an individual tasked to close the new sales opportunity.

8. The method of claim 1, wherein the one or more relevant features includes a feature indicative of a product associated with the new sales opportunity.

9. The method of claim 1, wherein the one or more relevant features includes a feature indicative of a quantity of a product associated with the new sales opportunity.

10. The method of claim 1, wherein the one or more relevant features includes a feature indicative of a geographic region associated with the new sales opportunity.

11. The method of claim 1, wherein the one or more relevant features includes a feature indicative of a deal price associated with the new sales opportunity.

12. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving information regarding a new sales opportunity from another computing device;
determining one or more relevant features from the information regarding the new sales opportunity, the one or more relevant features influencing predictions of an opportunity outcome and an opportunity duration;
generating, using a multi-target machine learning (ML) model, a first prediction of an opportunity outcome of the new sales opportunity and a second prediction of an opportunity duration of the new sales opportunity based on the determined one or more relevant features; and
sending the first and second predictions to the another computing device.

13. The computing device of claim 12, wherein the multi-target ML model includes a multi-output deep neural network (DNN).

14. The computing device of claim 13, wherein the multi-output DNN predicts a classification response and a regression response, wherein the classification response is the first prediction of the opportunity outcome of the new sales opportunity and the regression response is the second prediction of the opportunity duration of the new sales opportunity.

15. The computing device of claim 12, wherein the multi-target ML model is generated using a modeling dataset generated from a corpus of historical sales opportunity and deal closure data of an organization.

16. The computing device of claim 12, wherein the one or more relevant features includes a feature indicative of one of a customer associated with the new sales opportunity, a type of opportunity associated with the new sales opportunity, an individual tasked to close the new sales opportunity, a product associated with the new sales opportunity, a quantity of the product associated with the new sales opportunity, a geographic region associated with the new sales opportunity, or a deal price associated with the new sales opportunity.

17. A non-transitory machine-readable medium encoding instructions that when executed by one or more processors cause a process to be carried out, the process including:
receiving information regarding a new sales opportunity from a computing device;
determining one or more relevant features from the information regarding the new sales opportunity, the one or more relevant features influencing predictions of an opportunity outcome and an opportunity duration;
generating, using a multi-target machine learning (ML) model, a first prediction of an opportunity outcome of the new sales opportunity and a second prediction of an opportunity duration of the new sales opportunity based on the determined one or more relevant features; and
sending the first and second predictions to the computing device.

18. The machine-readable medium of claim 17, wherein the multi-target ML model includes a multi-output deep neural network (DNN).

19. The machine-readable medium of claim 18, wherein the multi-output DNN predicts a classification response and a regression response, wherein the classification response is the first prediction of an opportunity outcome of the new sales opportunity and the regression response is the second prediction of an opportunity duration of the new sales opportunity.

20. The machine-readable medium of claim 17, wherein the multi-target ML model is generated using a modeling dataset generated from a corpus of historical sales opportunity and deal closure data of an organization.
